(19) United States
(12) Patent Application Publication
(10) Pub. No.: US 2011/0004455 A1
(43) Pub. Date: Jan. 6, 2011

(54) Designing a Network

(76) Inventors: Diego Caviglia, Savona (IT); Giulio Bottari, Livorno (IT)

Correspondence Address: POTOMAC PATENT GROUP PLLC, P. O. BOX 270, FREDERICKSBURG, VA, 22404, US

(21) Appl. No.: 12/678,278

(22) PCT Filed: Sep. 24, 2008
(86) PCT No.: PCT/EP08/62803

§ 371 Date: Sep. 9, 2010

Related U.S. Application Data
(60) Provisional application No. 60/975,831, filed on Sep. 28, 2007.

(51) Int. Cl. G06F 17/50

(52) U.S. Cl. 703/13

(57) ABSTRACT

A method of designing a network given a set of network nodes, a set of adjacencies defining which nodes can be connected together directly and so are topologically adjacent and a traffic matrix comprising a plurality of entries each indicating a source node, a destination node and a number being the number of connections from the source node to the destination node that are to be present in the network; the method comprising the steps of: simulating the network nodes and the adjacencies thereof to generate a simulated network; simulating applying the traffic matrix entry by entry, each application of an entry causing a number of links consistent with the entry to be simulated between the source and destination nodes indicated in the entry, via a chain of topologically adjacent nodes; simulating the effect of at least one failure on the simulated network, including simulating the re-routing of the links onto a replacement chain where the chain is broken; determining the number of links between each pair of topologically adjacent nodes; repeating these steps for a plurality of iterations, the order in which the entries in the traffic matrix and the faults are applied being different in different iterations; for each iteration and for each topologically adjacent pair of nodes, determining an average number of links between the pair of nodes for all iterations so far; for each iteration and for each pair of topologically adjacent pair of nodes, determining a variance in the average number of links for all iterations so far; for each iteration, determining an average variance in the average number of links for all iterations so far, the average being taken across the entire network; for each iteration, determining a variance in the variances in the average number of links for all iterations so far, the variance being taken across the entire network; determining when to cease iterating based upon the variance in the variances in the average number of links.

### TECHNICAL FIELD

This invention relates to a method of designing a network.

### BACKGROUND

Capacity planning—determining the necessary amount of resources to satisfy a certain traffic matrix given the network topology and the required traffic survivability—is one of the most challenging tasks a network architect is required to perform. A traffic matrix contains a plurality of entries each describing the number of circuits to be created between a source and a destination or set of destinations. The capacity planning may also contain any of the following inputs:
the required protection/restoration scheme, e.g. 1+1 protected, Fast ReRoute (FRR), On The Fly (the protection circuit is calculated and implemented at failure time), SNCP; (Subnetwork Connection Protection; basically, path 1+1).
the required diversity between worker and protection/restoration circuit (link, node or SRLG—shared risk link groups);
resources (link, node or SRLG) to be included or excluded during the route computation for the circuits;
traffic parameters for the circuit(s) e.g. the bandwidth, CoS (class of service);
the physical topology of the network, that is, the connectivity relationship among the network elements;
the required network survivability, that is, the number and type of the failure(s) the network must survive (e.g. double links failure, single SRLG failure, . . . ) and the order of application of failures (deterministic or stochastic);
an ordered list of network interface to be used during the capacity planning process, such that a user can select a priori, that is, before the simulation runs, which kind of network interfaces (e.g. which capacity, STM64, STM16, 10 Gb, 100 Mb, etc) must be used or not used during the capacity planning process.

The outcome of the capacity planning process is the number and type of the needed resources. The resulting network can be saved as inventory report and used to purchase the required material.

The main technical and theoretical problem with the capacity planning is due to the fact that the final result is dependent on:
The sequence the traffic matrix is applied, that is, the order the circuits are created in the network
The order the failures are applied in the network

Given the above, the only way to be sure that the capacity planning results are valid for each sequence of both circuit creation and failures is to run the simulation for each possible case that is a NP complex problem. It easy to see that given a traffic matrix with N entries there are N! possible sequences of applying it.

An already available planning tool (ON-Planner) performs capacity planning with a heuristic algorithm.

Each Capacity Planning instance allocates automatically enough resources in order to satisfy increasing traffic (given by a Traffic Matrix) and/or to survive to a specified combination of faults assuming a certain order of circuit creation and performing a certain number of procedure steps. An Automatic Optimization process has been introduced to launch several instances of Capacity Planning aiming at the stability of the network resources. The process ends when an optimal and stable solution is obtained.

This Automatic Optimization is meaningful only if:
The Traffic Matrix is applied in random order and/or
The fault sequence generation is random

The Automatic Optimization is stopped when a set of consecutive Capacity Planning instances (i.e. 3 consecutive iterations) brings to the same result in terms of network upgrades.

At the time being, the automatic optimization works as follow:
An ideal scenario is considered (no faults are simulated in the network). Traffic matrix is applied several times by adding required ports and removing the unused ones until no more ports are added or removed for 3 consecutive iterations.
On the network optimized for the ideal scenario, carrying the traffic updated by the traffic matrix, a set of faults (on Link, SRLG, NE . . . ) is produced and ports are added or removed to support the new traffic in presence of faults. The automatic optimization is stopped when no more ports are added or removed for 3 consecutive iterations.

### SUMMARY

According to a first aspect of the invention, there is provided a method of designing a network given a set of network nodes, a set of adjacencies defining which nodes can be connected together directly and so are topologically adjacent and a traffic matrix comprising a plurality of entries each indicating a source node, a destination node and a number being the number of connections from the source node to the destination node that are to be present in the network;
the method comprising the steps of:
a) simulating the network nodes and the adjacencies thereof to generate a simulated network;
b) simulating applying the traffic matrix entry by entry, each application of an entry causing a number of links consistent with the entry to be simulated between the source and destination nodes indicated in the entry, via a chain of topologically adjacent nodes;
c) simulating the effect of at least one failure on the simulated network, including simulating the re-routing of the links onto a replacement chain where the chain is broken;
d) determining the number of links between each pair of topologically adjacent nodes;
e) repeating steps (a) to (d) for a plurality of iterations, the order in which the entries in the traffic matrix and the faults are applied being different in different iterations;
f) for each iteration and for each topologically adjacent pair of nodes, determining an average number of links between the pair of nodes for all iterations so far;
g) for each iteration and for each pair of topologically adjacent pair of nodes, determining a variance in the average number of links for all iterations so far;
h) for each iteration, determining an average variance in the average number of links for all iterations so far, the average being taken across the entire network;
i) for each iteration, determining a variance in the variances in the average number of links for all iterations so far, the variance being taken across the entire network; and
j) determining when to cease iterating based upon the variance in the variances in the average number of links.

By using the variance in the variance of the average number of links between the nodes, it can be determined when a sufficient number of iterations have been performed rather than simply requiring a fixed number. This reduces the need to calculate all the possible combinations of the order in which the traffic matrix and the faults are applied.

Preferably, the method comprises the step of storing and/or outputting, as a number of links to be provided between each topologically adjacent pair of nodes, the average number of links for that pair of nodes. The storing may be in a memory, hard disc or any other storage medium of a computer, which may be used to carry out the method. The outputting may be on a screen, printed out, or as a data file or any other suitable method.

The method may further comprise implementing the network in line with the number of links to be provided between each topologically adjacent pair of nodes.

Step (j) of the method may comprise determining whether the variance in the variances in the average number of links is below a threshold.

Alternatively, it may comprise determining whether the variance in the variances in the average number of links has converged to within a predetermined margin of error. The Tchebycheff inequality can be used as criterion to stop the simulation. Tchebycheff inequality assures that
At least 75% of the values are included in μ−2σ and μ+2σ
At least 88% of the values are included in μ−3σ e μ+3σ
At least 93% of the values are included in μ−4σ e μ−4σ
where μ is the average and σ is the variance.

The entries in the traffic matrix may also each comprise an indication of the protection desired for the link. This may comprise at least one of the following:
1:1 protection, where a backup channel is provided for every link
1:N protection, where a backup channel is provided for every N links
Fast ReRoute (FRR), where every link in a chain is protected by a backup path that commences from the first node in the link that can be activated should that link fail
On the fly, where the protection circuit is calculated and implemented at failure time
Shared risk link group, where any protection circuit cannot be carried over a physical link that is likely to fail at the same time as the link itself (for example, being on the same optical fiber)
Link or node diversity; link diversity means that protection path and failed one do not share any links while node diversity requires that no node is shared.

Step (b) may comprise simulating both the link and the protection desired. Step (c) may comprise simulating rerouting of a failed link based on the protection applied to the link in line with the protection desired.

The set of adjacencies may include data relating to the physical connections between the nodes; for example, data may be included that indicates that a given physical connection is carried over the same conduit (fiber, cable, etc) as another physical connection.

The entries in the traffic matrix may comprise an indication of the bandwidth to be carried by the links. The entries may also comprise an indication of the Class or Quality of Service (CoS/QoS) to be carried by the link.

The network may be a synchronous network, such as SDH (synchronous digital hierarchy) or SONET (synchronous optical networking) networks. Alternative networks include photonic, G.709, T-MPLS, PBB-TE, MPLS.

The average may be the mean.

The method may be implemented as a computer program, running on an appropriate computer.

### BRIEF DESCRIPTION OF THE DRAWINGS

FIG. 1 shows a flowchart showing the operation of an embodiment of the invention;

FIG. 2 shows an example network to which the method illustrated in FIG. 1 can be applied; and

FIGS. 3 and 4 shows a graph of the average variance in the number of links and the variance in the average variance in the number of links respectively in an example application of the method of FIG. 1 to the network of FIG. 2.

### DETAILED DESCRIPTION

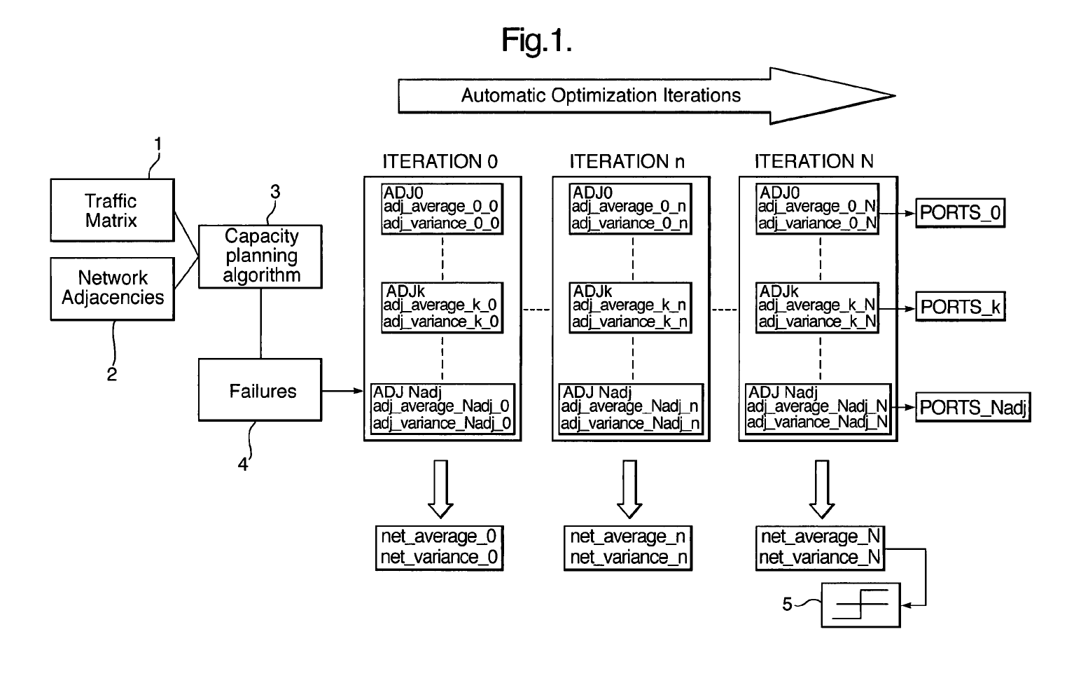

The set of steps shown with respect to FIG. 1 defines the heuristic algorithm to be used to perform the capacity planning according to a first embodiment of a method according to the present invention. In this embodiment, a number of iterations of a capacity planning algorithm 3 are carried out. This can be any commonly used algorithm, such as that employed in the software product “ON-Planner”.

The algorithm takes as an input a traffic matrix 1 and a description of the topological adjacencies of the nodes 2 (that is, which nodes are physically linked to which other nodes). Each entry in the traffic matrix comprises a source and one or more destination nodes for a particular desired link, together with other such data as the capacity planning algorithm may require, such as the bandwidth desired for the link, the protection required for the link and so on.

At each iteration, the capacity planning algorithm 3 applies the entries in the traffic matrix in a random order, so that the arrangement of the circuits set up by the algorithm may differ from iteration to iteration. The output of the capacity planning algorithm is a number of circuits to be provided between each pairing of topologically adjacent nodes. There are considered to be no bandwidth constraints during the capacity planning simulation; that is, circuits are routed counting that there are infinite resources in the network.

The next stage within each iteration is to apply a randomly ordered series of network failures (the order changing at each iteration), and to simulate the effect that these would have on the network's protection mechanisms, the rerouting of circuits and so on. A suitable algorithm for this is known from the software product “ON-Planner”. Circuits rerouted are added to the number of circuits between each pairing of topologically adjacent network nodes.

Thus, at each iteration, for each pairing of topologically adjacent nodes, a number of circuits will be indicated.

For the first iteration, Iteration 0 in FIG. 1, for each topologically adjacent pair of nodes or “adjacency” (adj k) the number of circuits is stored in adj_circui_k_0, including the addition of the circuits that were rerouted because of the simulation of failures.

For this initial iteration, the average (in this embodiment the mean is employed as the average) number of circuits for each adjacency will be equal to the actual number of circuits for that adjacency—taking the mean of a single number is a mathematical identity. The variance of number of circuits for each adjacency will be zero, as will the average variance of number of circuits over the whole network and the variance in the variances for each adjacency.

The simulation of the network is then cleaned; all the circuits are deleted and all the failure(s) are removed.

For the next and each succeeding iteration, the method operates in the same manner, applying the traffic matrix and failures so as to arrive at a number of circuits for each adjacency stored in adj_circuit_k_n, where n is the number of the iteration.

At the end of Iteration n, the following data are calculated as follows:
for each adjacency k the average number of connections over that adjacency for all iterations so far:

$$adj\_average \_k \_n = \frac{{\sum }_{j = 0}^{n} adj\_circuit \_k \_j}{n}$$

for each adjacency k the variance in the number of circuits on that adjacency for all iterations so far:

$$adj\_variance \_k \_n = \frac{1}{n} \cdot ( {\sum }_{i = 0}^{n} {( adj\_circuit \_k \_i - adj\_average \_k \_n )}^{2} )$$

for the network as a whole, the average variance (where Nadj is the total number of adjacencies):

$$net\_average \_n = \frac{{\sum }_{k = 1}^{Nadj} adj\_variance \_k \_n}{Nadj}$$

for the network as a whole, the variance in the individual variances:

$$net\_variance \_n = \frac{{\sum }_{k = 1}^{Nadj} {( adj\_variance \_k \_n - adj\_average \_n )}^{2}}{Nadj}$$

The iterations continue until a criterion 5 is met; at the end of each iteration the simulation is cleaned as described above and the method carried out once more. The criterion is based upon the variance in the individual variances net_variance_n. When net_variance_n falls below a threshold or converges to within a certain limit, the iterations cease; in the Figures this is depicted as iteration N.

For each adjacency the adj_average_k_N is converted into port information given the policy requested by the operator. As example if adj_average_N is 60 and the technology is SDH then a STM64 port is allocated for that adjacency, because STM64 can host 60 VC4 circuits using a single fiber.

In order to determine the Threshold the Chebyshev inequality assures that:
at least the 75% of the values of net_average_i where i indicates a possible sequence of failures are contained in the interval:
   [net_average_n−2·net_variance_n;net_average_n+2·net_variance_n]
at least the 88% of the values will be between:
   [net_average_n−3·net_variance_n;net_average_n+3·net_variance_n]
at least the 93% of the values will be between:
   [net_average_n−4·net_variance_n;net_average_n+4·net_variance_n]

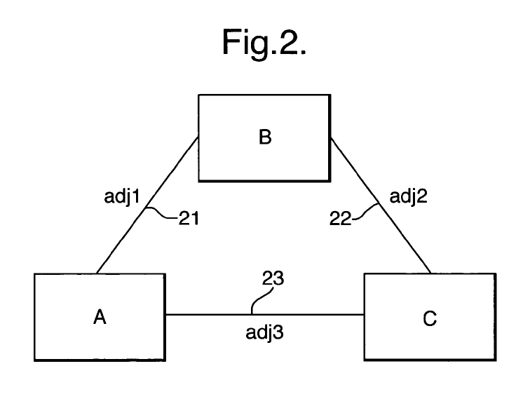

An example network on which the method according to the embodiment of the invention described above can be seen in FIG. 2 of the accompanying drawings. As will be apparent, this is a very simple network comprising three nodes A, B, C. All of the nodes are connected together, so that three are three adjacencies—adj1 21 between A and B, adj2 22 between B and C and adj3 23 between C and A. A total of 27 circuits are to be provided over the network.

The outputs of the capacity planning iterations are shown in Appendix A. For each of the 200 iterations, the number of circuits indicated by the capacity planning algorithm 3 after the faults 4 have been applied is shown in the columns adj1, adj2 and adj3. As can be seen in the Total Circuits column, these add up to 27.

For each adjacency and each iteration, the average number of circuits over that adjacency for all iterations up to the current one is displayed in the columns adj_average_1_n, adj_average_2_n and adj_average_3_n respectively. The corresponding variances in the number of circuits over each adjacency is displayed in adj_variance_1_n, adj_variance_2_n and adj_variance_3_n respectively. The average variance over all adjacencies is shown in net_average_n and the variance of the variances adj_variance_1_n, adj_variance_2_n and adj_variance_3_n is shown at net_variance_n.

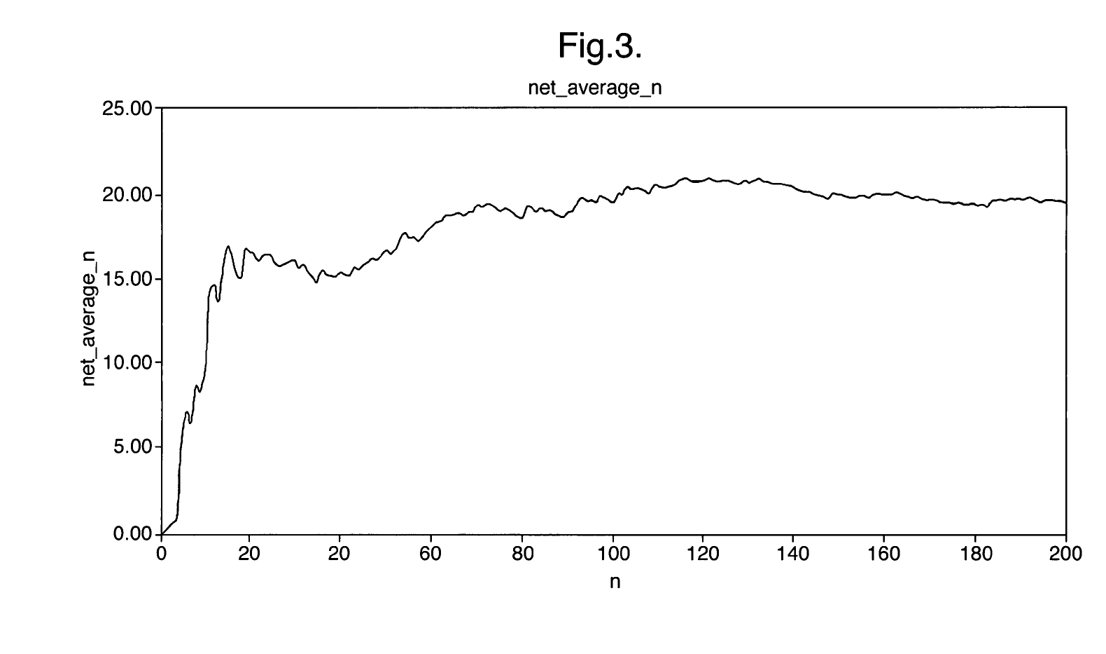

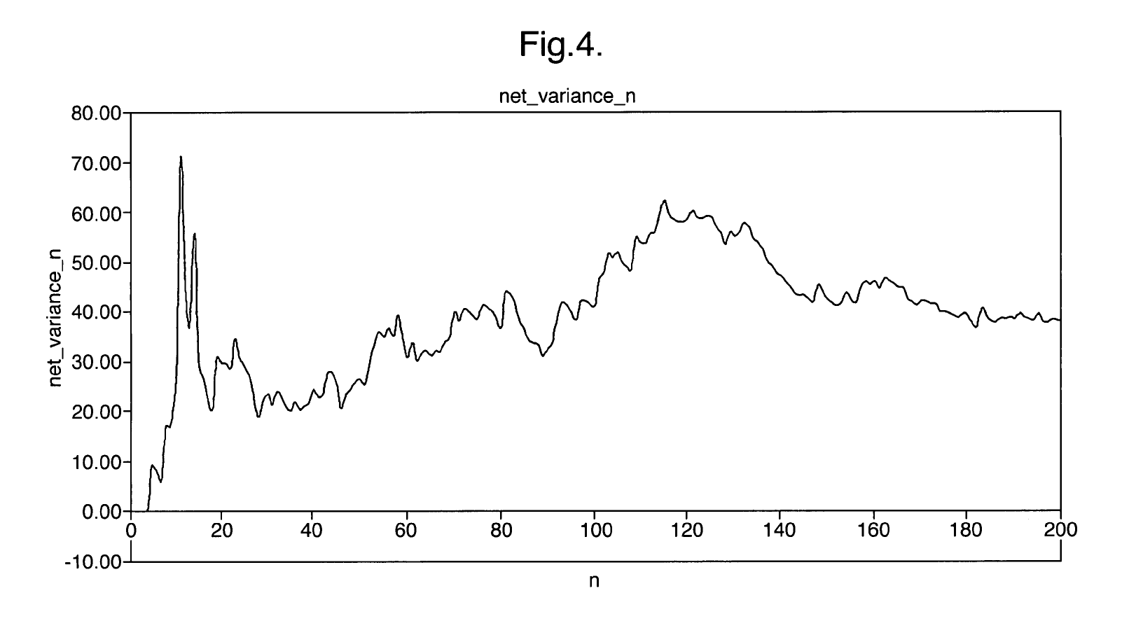

The results are shown graphically in FIGS. 3 and 4 of the accompanying drawings. FIG. 3 shows how the average variance changes as the number of iterations progresses. As can be seen, this converges to a value of about 30. In FIG. 4, the evolution of the variance in the individual variances is depicted; this converges at about 38. Once this convergence is complete, the iterations are stopped and the final average number of links adj_average_1_n (7.50), adj_average_2_n (7.35) and adj_average_3_n (12.16) for each adjacency are used to determine the number of circuits to apply to the network.

APPENDIX A
3 Adjacency
27 Circuits
200 instances of Capacity Planning

| CP Instances n | Adj1 | Adj2 | Adj3 | Tot Circuits | adj_average_1_n | adj_average_2_n | adj_average_3_n | adj_variance_1_n | adj_variance_2_n | adj_variance_3_n | net_average_n | net_variance_n |
|---|---|---|---|---|---|---|---|---|---|---|---|---|
| 1 | 10 | 5 | 12 | 27 | 10.00 | 5.00 | 12.00 | 0.00 | 0.00 | 0.00 | 0.00 | 0.00 |
| 2 | 8 | 7 | 12 | 27 | 9.00 | 6.00 | 12.00 | 0.50 | 0.50 | 0.00 | 0.33 | 0.06 |
| 3 | 11 | 4 | 12 | 27 | 9.67 | 5.33 | 12.00 | 0.93 | 0.93 | 0.00 | 0.62 | 0.19 |
| 4 | 9 | 8 | 10 | 27 | 9.50 | 6.00 | 11.50 | 0.76 | 1.69 | 0.56 | 1.00 | 0.24 |
| 5 | 5 | 2 | 20 | 27 | 8.60 | 5.20 | 13.20 | 3.20 | 3.40 | 9.70 | 5.43 | 9.10 |
| 6 | 6 | 12 | 9 | 27 | 8.17 | 6.33 | 12.50 | 3.45 | 8.19 | 10.12 | 7.25 | 7.87 |
| 7 | 10 | 7 | 10 | 27 | 8.43 | 6.43 | 12.14 | 3.31 | 7.07 | 9.33 | 6.57 | 6.17 |
| 8 | 5 | 2 | 20 | 27 | 8.00 | 5.88 | 13.13 | 4.02 | 8.06 | 14.07 | 8.72 | 17.07 |
| 9 | 6 | 4 | 17 | 27 | 7.78 | 5.67 | 13.56 | 3.92 | 7.47 | 13.83 | 8.41 | 16.79 |
| 10 | 8 | 12 | 7 | 27 | 7.80 | 6.30 | 12.90 | 3.54 | 9.97 | 15.93 | 9.81 | 25.61 |
| 11 | 12 | 14 | 1 | 27 | 8.18 | 7.00 | 11.82 | 4.54 | 13.52 | 25.12 | 14.39 | 70.97 |
| 12 | 15 | 3 | 9 | 27 | 8.75 | 6.67 | 11.58 | 7.42 | 13.52 | 23.58 | 14.84 | 44.43 |
| 13 | 7 | 8 | 12 | 27 | 8.62 | 6.77 | 11.62 | 7.05 | 12.59 | 21.78 | 13.81 | 36.91 |
| 14 | 8 | 16 | 3 | 27 | 8.57 | 7.43 | 11.00 | 6.57 | 16.94 | 24.79 | 16.10 | 55.73 |
| 15 | 17 | 2 | 8 | 27 | 9.13 | 7.07 | 10.80 | 10.25 | 17.52 | 23.66 | 17.15 | 30.04 |
| 16 | 12 | 7 | 8 | 27 | 9.31 | 7.06 | 10.63 | 10.06 | 16.43 | 22.62 | 16.37 | 26.26 |
| 17 | 11 | 6 | 10 | 27 | 9.41 | 7.00 | 10.59 | 9.62 | 15.52 | 21.31 | 15.48 | 22.76 |
| 18 | 12 | 2 | 13 | 27 | 9.56 | 6.72 | 10.72 | 9.42 | 15.90 | 20.41 | 15.24 | 20.35 |
| 19 | 3 | 3 | 21 | 27 | 9.21 | 6.53 | 11.26 | 10.95 | 15.71 | 24.33 | 17.00 | 30.63 |
| 20 | 5 | 6 | 16 | 27 | 9.00 | 6.50 | 11.50 | 11.21 | 14.94 | 24.12 | 16.76 | 29.46 |
| 21 | 8 | 12 | 7 | 27 | 8.95 | 6.76 | 11.29 | 10.71 | 15.54 | 23.85 | 16.70 | 29.42 |
| 22 | 9 | 10 | 8 | 27 | 8.95 | 6.91 | 11.14 | 10.23 | 15.26 | 23.21 | 16.23 | 28.57 |
| 23 | 11 | 12 | 4 | 27 | 9.04 | 7.13 | 10.83 | 9.95 | 15.63 | 24.23 | 16.60 | 34.45 |
| 24 | 15 | 6 | 6 | 27 | 9.29 | 7.08 | 10.63 | 10.89 | 15.03 | 24.11 | 16.68 | 30.47 |
| 25 | 14 | 7 | 6 | 27 | 9.48 | 7.08 | 10.44 | 11.27 | 14.43 | 23.93 | 16.55 | 28.95 |
| 26 | 12 | 7 | 8 | 27 | 9.58 | 7.08 | 10.35 | 11.07 | 13.87 | 23.23 | 16.05 | 27.02 |
| 27 | 4 | 9 | 14 | 27 | 9.37 | 7.15 | 10.48 | 11.72 | 13.49 | 22.82 | 16.01 | 23.72 |
| 28 | 3 | 11 | 13 | 27 | 9.14 | 7.29 | 10.57 | 12.65 | 13.50 | 22.22 | 16.12 | 18.70 |
| 29 | 6 | 4 | 17 | 27 | 9.03 | 7.17 | 10.79 | 12.53 | 13.38 | 22.78 | 16.23 | 21.57 |
| 30 | 10 | 12 | 5 | 27 | 9.07 | 7.33 | 10.60 | 12.15 | 13.66 | 23.07 | 16.29 | 23.34 |
| 31 | 11 | 5 | 11 | 27 | 9.13 | 7.26 | 10.61 | 11.87 | 13.38 | 22.33 | 15.86 | 21.30 |
| 32 | 8 | 2 | 17 | 27 | 9.09 | 7.09 | 10.81 | 11.53 | 13.78 | 22.83 | 16.05 | 23.83 |
| 33 | 9 | 9 | 9 | 27 | 9.09 | 7.15 | 10.76 | 11.18 | 13.46 | 22.23 | 15.63 | 22.67 |
| 34 | 12 | 6 | 9 | 27 | 9.18 | 7.12 | 10.71 | 11.09 | 13.10 | 21.66 | 15.28 | 21.00 |
| 35 | 10 | 4 | 13 | 27 | 9.20 | 7.03 | 10.77 | 10.79 | 12.99 | 21.18 | 14.99 | 19.99 |
| 36 | 1 | 7 | 19 | 27 | 8.97 | 7.03 | 11.00 | 12.26 | 12.63 | 22.37 | 15.75 | 21.93 |
| 37 | 7 | 10 | 10 | 27 | 8.92 | 7.11 | 10.97 | 12.03 | 12.51 | 21.79 | 15.44 | 20.20 |
| 38 | 8 | 3 | 16 | 27 | 8.89 | 7.00 | 11.11 | 11.73 | 12.61 | 21.85 | 15.40 | 20.96 |
| 39 | 12 | 9 | 6 | 27 | 8.97 | 7.05 | 10.97 | 11.66 | 12.38 | 21.92 | 15.32 | 21.88 |
| 40 | 8 | 1 | 18 | 27 | 8.95 | 6.90 | 11.15 | 11.39 | 12.94 | 22.55 | 15.63 | 24.35 |
| 41 | 7 | 11 | 9 | 27 | 8.90 | 7.00 | 11.10 | 11.21 | 13.02 | 22.11 | 15.44 | 22.75 |
| 42 | 5 | 6 | 16 | 27 | 8.81 | 6.98 | 11.21 | 11.28 | 12.73 | 22.13 | 15.38 | 23.11 |
| 43 | 3 | 4 | 20 | 27 | 8.67 | 6.91 | 11.42 | 11.77 | 12.63 | 23.32 | 15.91 | 27.62 |
| 44 | 12 | 8 | 7 | 27 | 8.75 | 6.93 | 11.32 | 11.74 | 12.37 | 23.22 | 15.78 | 27.75 |
| 45 | 1 | 10 | 16 | 27 | 8.58 | 7.00 | 11.42 | 12.76 | 12.29 | 23.17 | 16.07 | 25.20 |
| 46 | 15 | 1 | 11 | 27 | 8.72 | 6.87 | 11.41 | 13.34 | 12.77 | 22.67 | 16.26 | 20.58 |
| 47 | 13 | 10 | 4 | 27 | 8.81 | 6.94 | 11.26 | 13.43 | 12.70 | 23.31 | 16.48 | 23.39 |
| 48 | 12 | 9 | 6 | 27 | 8.88 | 6.98 | 11.15 | 13.35 | 12.52 | 23.37 | 16.42 | 24.31 |
| 49 | 8 | 1 | 18 | 27 | 8.86 | 6.86 | 11.29 | 13.09 | 12.97 | 23.81 | 16.63 | 25.84 |
| 50 | 1 | 8 | 18 | 27 | 8.70 | 6.88 | 11.42 | 14.02 | 12.73 | 24.20 | 16.99 | 26.33 |
| 51 | 7 | 7 | 13 | 27 | 8.67 | 6.88 | 11.45 | 13.80 | 12.48 | 23.78 | 16.69 | 25.42 |
| 52 | 3 | 4 | 20 | 27 | 8.56 | 8.83 | 11.62 | 14.13 | 12.40 | 24.67 | 17.07 | 29.42 |
| 53 | 11 | 14 | 2 | 27 | 8.60 | 6.96 | 11.43 | 13.97 | 13.10 | 25.89 | 17.65 | 34.03 |
| 54 | 1 | 7 | 19 | 27 | 8.46 | 6.96 | 11.57 | 14.74 | 12.86 | 26.43 | 18.01 | 36.03 |
| 55 | 8 | 6 | 13 | 27 | 8.45 | 6.95 | 11.60 | 14.48 | 12.64 | 25.98 | 17.70 | 34.87 |
| 56 | 5 | 4 | 18 | 27 | 8.39 | 6.89 | 11.71 | 14.42 | 12.56 | 26.22 | 17.74 | 36.59 |
| 57 | 6 | 8 | 13 | 27 | 8.35 | 6.91 | 11.74 | 14.27 | 12.38 | 25.79 | 17.47 | 35.20 |
| 58 | 14 | 10 | 3 | 27 | 8.45 | 6.97 | 11.59 | 14.55 | 12.31 | 26.62 | 17.83 | 39.49 |
| 59 | 0 | 13 | 14 | 27 | 8.31 | 7.07 | 11.63 | 15.48 | 12.70 | 26.26 | 18.14 | 34.24 |
| 60 | 0 | 12 | 15 | 27 | 8.17 | 7.15 | 11.68 | 16.33 | 12.88 | 26.01 | 18.40 | 30.89 |
| 61 | 5 | 2 | 20 | 27 | 8.11 | 7.07 | 11.82 | 16.22 | 13.09 | 26.68 | 18.66 | 33.77 |
| 62 | 4 | 14 | 9 | 27 | 8.05 | 7.18 | 11.77 | 16.22 | 13.63 | 26.37 | 18.74 | 30.25 |
| 63 | 0 | 8 | 19 | 27 | 7.92 | 7.19 | 11.89 | 16.96 | 13.42 | 26.76 | 19.05 | 31.82 |
| 64 | 7 | 2 | 18 | 27 | 7.91 | 7.11 | 11.98 | 16.71 | 13.62 | 26.90 | 19.08 | 32.22 |
| 65 | 1 | 10 | 16 | 27 | 7.80 | 7.15 | 12.05 | 17.16 | 13.53 | 26.73 | 19.14 | 30.99 |
| 66 | 13 | 8 | 6 | 27 | 7.88 | 7.17 | 11.95 | 17.30 | 13.34 | 26.86 | 19.17 | 32.22 |
| 67 | 13 | 6 | 8 | 27 | 7.96 | 7.15 | 11.90 | 17.42 | 13.16 | 26.69 | 19.09 | 31.90 |
| 68 | 1 | 7 | 19 | 27 | 7.85 | 7.15 | 12.00 | 17.86 | 12.97 | 27.02 | 19.28 | 33.91 |
| 69 | 5 | 4 | 18 | 27 | 7.81 | 7.10 | 12.09 | 17.71 | 12.92 | 27.13 | 19.25 | 34.86 |
| 70 | 1 | 4 | 22 | 27 | 7.71 | 7.06 | 12.23 | 18.10 | 12.87 | 28.11 | 19.69 | 39.98 |
| 71 | 3 | 10 | 14 | 27 | 7.65 | 7.10 | 12.25 | 18.15 | 12.80 | 27.75 | 19.57 | 38.26 |
| 72 | 11 | 12 | 4 | 27 | 7.69 | 7.17 | 12.14 | 18.05 | 12.95 | 28.29 | 19.76 | 40.68 |
| 73 | 13 | 6 | 8 | 27 | 7.77 | 7.15 | 12.08 | 18.18 | 12.79 | 28.13 | 19.70 | 40.37 |
| 74 | 7 | 11 | 9 | 27 | 7.76 | 7.20 | 12.04 | 17.94 | 12.81 | 27.88 | 19.54 | 39.09 |
| 75 | 10 | 8 | 9 | 27 | 7.79 | 7.21 | 12.00 | 17.77 | 12.65 | 27.62 | 19.35 | 38.61 |
| 76 | 13 | 10 | 4 | 27 | 7.86 | 7.25 | 11.89 | 17.88 | 12.58 | 28.08 | 19.52 | 41.36 |
| 77 | 10 | 9 | 8 | 27 | 7.88 | 7.27 | 11.84 | 17.71 | 12.46 | 27.91 | 19.36 | 41.14 |
| 78 | 8 | 10 | 9 | 27 | 7.88 | 7.31 | 11.81 | 17.48 | 12.39 | 27.65 | 19.18 | 40.24 |
| 79 | 6 | 10 | 11 | 27 | 7.86 | 7.34 | 11.80 | 17.31 | 12.32 | 27.31 | 18.98 | 38.82 |
| 80 | 10 | 1 | 16 | 27 | 7.89 | 7.26 | 11.85 | 17.14 | 12.66 | 27.18 | 19.00 | 36.86 |
| 81 | 0 | 3 | 24 | 27 | 7.79 | 7.21 | 12.00 | 17.68 | 12.72 | 28.62 | 19.68 | 44.13 |
| 82 | 6 | 6 | 15 | 27 | 7.77 | 7.20 | 12.04 | 17.50 | 12.59 | 28.38 | 19.49 | 43.56 |
| 83 | 11 | 5 | 11 | 27 | 7.81 | 7.17 | 12.02 | 17.42 | 12.49 | 28.05 | 19.32 | 42.18 |
| 84 | 0 | 14 | 13 | 27 | 7.71 | 7.25 | 12.04 | 17.92 | 12.88 | 27.73 | 19.51 | 38.00 |
| 85 | 6 | 10 | 11 | 27 | 7.69 | 7.28 | 12.02 | 17.74 | 12.82 | 27.42 | 19.33 | 36.77 |
| 86 | 4 | 14 | 9 | 27 | 7.65 | 7.36 | 11.99 | 17.69 | 13.18 | 27.20 | 19.36 | 34.14 |
| 87 | 4 | 8 | 15 | 27 | 7.61 | 7.37 | 12.02 | 17.64 | 13.04 | 26.99 | 19.22 | 33.71 |
| 88 | 9 | 9 | 9 | 27 | 7.63 | 7.39 | 11.99 | 17.46 | 12.92 | 26.79 | 19.05 | 33.33 |
| 89 | 12 | 2 | 13 | 27 | 7.67 | 7.33 | 12.00 | 17.47 | 13.09 | 26.50 | 19.02 | 31.15 |
| 90 | 6 | 0 | 21 | 27 | 7.66 | 7.24 | 12.10 | 17.31 | 13.53 | 27.08 | 19.31 | 32.61 |
| 91 | 5 | 3 | 19 | 27 | 7.63 | 7.20 | 12.18 | 17.19 | 13.57 | 27.30 | 19.35 | 33.72 |
| 92 | 13 | 14 | 0 | 27 | 7.68 | 7.27 | 12.04 | 17.31 | 13.92 | 28.58 | 19.94 | 39.24 |
| 93 | 12 | 12 | 3 | 27 | 7.73 | 7.32 | 11.95 | 17.32 | 14.00 | 29.13 | 20.15 | 42.13 |
| 94 | 5 | 8 | 14 | 27 | 7.70 | 7.33 | 11.97 | 17.22 | 13.86 | 28.86 | 19.98 | 41.33 |
| 95 | 6 | 14 | 7 | 27 | 7.68 | 7.40 | 11.92 | 17.06 | 14.17 | 28.81 | 20.02 | 40.08 |
| 96 | 12 | 4 | 11 | 27 | 7.73 | 7.36 | 11.91 | 17.08 | 14.14 | 28.52 | 19.91 | 38.48 |
| 97 | 0 | 5 | 22 | 27 | 7.65 | 7.34 | 12.01 | 17.50 | 14.05 | 29.26 | 20.27 | 42.35 |
| 98 | 9 | 11 | 7 | 27 | 7.66 | 7.38 | 11.96 | 17.34 | 14.04 | 29.21 | 20.20 | 42.41 |
| 99 | 8 | 9 | 10 | 27 | 7.67 | 7.39 | 11.94 | 17.17 | 13.93 | 28.95 | 20.02 | 41.67 |
| 100 | 9 | 10 | 8 | 27 | 7.68 | 7.42 | 11.90 | 17.02 | 13.86 | 28.81 | 19.90 | 41.44 |
| 101 | 2 | 1 | 24 | 27 | 7.62 | 7.36 | 12.02 | 17.16 | 14.12 | 29.95 | 20.41 | 47.06 |
| 102 | 12 | 9 | 6 | 27 | 7.67 | 7.37 | 11.96 | 17.18 | 14.01 | 30.01 | 20.40 | 47.85 |
| 103 | 4 | 0 | 23 | 27 | 7.63 | 7.30 | 12.07 | 17.14 | 14.39 | 30.87 | 20.80 | 52.01 |
| 104 | 3 | 9 | 15 | 27 | 7.59 | 7.32 | 12.10 | 17.17 | 14.28 | 30.66 | 20.70 | 50.95 |
| 105 | 4 | 4 | 19 | 27 | 7.55 | 7.29 | 12.16 | 17.13 | 14.24 | 30.81 | 20.73 | 52.22 |
| 106 | 10 | 1 | 16 | 27 | 7.58 | 7.23 | 12.20 | 17.03 | 14.47 | 30.66 | 20.72 | 50.47 |
| 107 | 9 | 4 | 14 | 27 | 7.59 | 7.20 | 12.21 | 16.88 | 14.43 | 30.40 | 20.57 | 49.29 |
| 108 | 9 | 8 | 10 | 27 | 7.60 | 7.20 | 12.19 | 16.75 | 14.31 | 30.16 | 20.41 | 48.60 |
| 109 | 1 | 1 | 25 | 27 | 7.54 | 7.15 | 12.31 | 16.99 | 14.52 | 31.36 | 20.96 | 55.16 |
| 110 | 7 | 10 | 10 | 27 | 7.54 | 7.17 | 12.29 | 16.83 | 14.46 | 31.13 | 20.81 | 54.18 |
| 111 | 8 | 12 | 7 | 27 | 7.54 | 7.22 | 12.24 | 16.68 | 14.54 | 31.09 | 20.77 | 54.03 |
| 112 | 4 | 3 | 20 | 27 | 7.51 | 7.18 | 12.31 | 16.64 | 14.56 | 31.34 | 20.85 | 55.77 |
| 113 | 9 | 12 | 6 | 27 | 7.52 | 7.22 | 12.26 | 16.52 | 14.64 | 31.41 | 20.86 | 56.31 |
| 114 | 4 | 1 | 22 | 27 | 7.49 | 7.17 | 12.34 | 16.48 | 14.84 | 31.96 | 21.09 | 59.45 |
| 115 | 12 | 12 | 3 | 27 | 7.53 | 7.21 | 12.26 | 16.51 | 14.91 | 32.42 | 21.28 | 62.49 |
| 116 | 11 | 0 | 16 | 27 | 7.56 | 7.15 | 12.29 | 16.47 | 15.23 | 32.26 | 21.32 | 60.14 |
| 117 | 5 | 10 | 12 | 27 | 7.54 | 7.17 | 12.29 | 16.38 | 15.18 | 31.99 | 21.18 | 58.67 |
| 118 | 7 | 13 | 7 | 27 | 7.53 | 7.22 | 12.25 | 16.25 | 15.32 | 31.95 | 21.17 | 58.22 |
| 119 | 7 | 2 | 18 | 27 | 7.53 | 7.18 | 12.29 | 16.11 | 15.41 | 31.95 | 21.16 | 58.33 |
| 120 | 7 | 1 | 19 | 27 | 7.53 | 7.13 | 12.35 | 15.98 | 15.60 | 32.06 | 21.21 | 58.83 |
| 121 | 9 | 14 | 4 | 27 | 7.54 | 7.18 | 12.28 | 15.87 | 15.85 | 32.36 | 21.36 | 60.49 |
| 122 | 5 | 10 | 12 | 27 | 7.52 | 7.20 | 12.28 | 15.79 | 15.79 | 32.09 | 21.22 | 59.08 |
| 123 | 10 | 9 | 8 | 27 | 7.54 | 7.22 | 12.24 | 15.71 | 15.69 | 31.98 | 21.12 | 58.91 |
| 124 | 1 | 7 | 19 | 27 | 7.48 | 7.22 | 12.30 | 15.92 | 15.56 | 32.08 | 21.19 | 59.38 |
| 125 | 8 | 1 | 18 | 27 | 7.49 | 7.17 | 12.34 | 15.80 | 15.74 | 32.08 | 21.21 | 59.15 |
| 126 | 4 | 12 | 11 | 27 | 7.46 | 7.21 | 12.33 | 15.77 | 15.80 | 31.84 | 21.14 | 57.32 |
| 127 | 12 | 5 | 10 | 27 | 7.50 | 7.19 | 12.31 | 15.80 | 15.71 | 31.63 | 21.05 | 56.03 |
| 128 | 13 | 2 | 12 | 27 | 7.54 | 7.15 | 12.31 | 15.91 | 15.79 | 31.39 | 21.03 | 53.63 |
| 129 | 12 | 12 | 3 | 27 | 7.57 | 7.19 | 12.24 | 15.94 | 15.85 | 31.81 | 21.20 | 56.25 |
| 130 | 6 | 11 | 10 | 27 | 7.56 | 7.22 | 12.22 | 15.84 | 15.84 | 31.60 | 21.09 | 55.21 |
| 131 | 7 | 0 | 20 | 27 | 7.56 | 7.16 | 12.28 | 15.72 | 16.11 | 31.81 | 21.21 | 56.20 |
| 132 | 10 | 13 | 4 | 27 | 7.58 | 7.20 | 12.22 | 15.64 | 16.24 | 32.08 | 21.32 | 57.96 |
| 133 | 7 | 7 | 13 | 27 | 7.57 | 7.20 | 12.23 | 15.53 | 16.12 | 31.85 | 21.17 | 57.11 |
| 134 | 13 | 2 | 12 | 27 | 7.61 | 7.16 | 12.22 | 15.63 | 16.20 | 31.61 | 21.15 | 54.80 |
| 135 | 5 | 7 | 15 | 27 | 7.59 | 7.16 | 12.24 | 15.56 | 16.08 | 31.43 | 21.02 | 54.20 |
| 136 | 5 | 13 | 9 | 27 | 7.57 | 7.21 | 12.22 | 15.50 | 16.21 | 31.28 | 20.99 | 52.95 |
| 137 | 1 | 12 | 14 | 27 | 7.53 | 7.24 | 12.23 | 15.69 | 16.26 | 31.07 | 21.01 | 50.70 |
| 138 | 10 | 2 | 15 | 27 | 7.54 | 7.20 | 12.25 | 15.62 | 16.33 | 30.90 | 20.95 | 49.56 |
| 139 | 12 | 4 | 11 | 27 | 7.58 | 7.18 | 12.24 | 15.65 | 16.29 | 30.69 | 20.88 | 48.21 |
| 140 | 7 | 9 | 11 | 27 | 7.57 | 7.19 | 12.24 | 15.54 | 16.20 | 30.48 | 20.74 | 47.52 |
| 141 | 4 | 11 | 12 | 27 | 7.55 | 7.22 | 12.23 | 15.52 | 16.18 | 30.27 | 20.66 | 46.24 |
| 142 | 12 | 5 | 10 | 27 | 7.58 | 7.20 | 12.22 | 15.55 | 16.10 | 30.09 | 20.58 | 45.24 |
| 143 | 13 | 4 | 10 | 27 | 7.62 | 7.18 | 12.20 | 15.64 | 16.06 | 29.91 | 20.54 | 43.95 |
| 144 | 8 | 4 | 15 | 27 | 7.62 | 7.16 | 12.22 | 15.54 | 16.02 | 29.76 | 20.44 | 43.46 |
| 145 | 11 | 9 | 7 | 27 | 7.64 | 7.17 | 12.19 | 15.51 | 15.93 | 29.74 | 20.39 | 43.69 |
| 146 | 4 | 10 | 13 | 27 | 7.62 | 7.19 | 12.19 | 15.49 | 15.88 | 29.54 | 20.30 | 42.68 |
| 147 | 5 | 7 | 15 | 27 | 7.60 | 7.19 | 12.21 | 15.43 | 15.77 | 29.39 | 20.20 | 42.28 |
| 148 | 12 | 14 | 1 | 27 | 7.63 | 7.24 | 12.14 | 15.46 | 15.97 | 30.03 | 20.49 | 45.58 |
| 149 | 11 | 2 | 14 | 27 | 7.65 | 7.20 | 12.15 | 15.43 | 16.05 | 29.85 | 20.44 | 44.33 |
| 150 | 3 | 12 | 12 | 27 | 7.62 | 7.23 | 12.15 | 15.47 | 16.09 | 29.65 | 20.40 | 42.83 |
| 151 | 11 | 6 | 10 | 27 | 7.64 | 7.23 | 12.13 | 15.44 | 15.99 | 29.49 | 20.31 | 42.18 |
| 152 | 11 | 5 | 11 | 27 | 7.66 | 7.21 | 12.13 | 15.41 | 15.92 | 29.30 | 20.21 | 41.35 |
| 153 | 6 | 2 | 19 | 27 | 7.65 | 7.18 | 12.17 | 15.33 | 15.99 | 29.41 | 20.24 | 42.11 |
| 154 | 11 | 13 | 3 | 27 | 7.68 | 7.21 | 12.11 | 15.30 | 16.10 | 29.76 | 20.39 | 44.03 |
| 155 | 3 | 11 | 13 | 27 | 7.65 | 7.24 | 12.12 | 15.34 | 16.09 | 29.57 | 20.34 | 42.77 |
| 156 | 9 | 6 | 12 | 27 | 7.65 | 2.23 | 12.12 | 15.25 | 16.00 | 29.38 | 20.21 | 42.15 |
| 157 | 3 | 1 | 23 | 27 | 2.62 | 1.19 | 12.18 | 15.29 | 16.14 | 29.94 | 20.46 | 45.09 |
| 158 | 5 | 2 | 20 | 27 | 7.61 | 7.16 | 12.23 | 15.24 | 16.21 | 30.13 | 20.53 | 46.31 |
| 159 | 8 | 8 | 11 | 27 | 7.61 | 7.16 | 12.23 | 15.14 | 16.11 | 29.95 | 20.40 | 45.77 |
| 160 | 7 | 1 | 19 | 27 | 7.61 | 7.13 | 12.27 | 15.05 | 16.24 | 30.05 | 20.45 | 46.33 |
| 161 | 4 | 13 | 10 | 27 | 7.58 | 7.16 | 12.25 | 15.04 | 16.35 | 29.90 | 20.43 | 45.09 |
| 162 | 11 | 13 | 3 | 27 | 7.60 | 7.20 | 12.20 | 15.02 | 16.46 | 30.23 | 20.57 | 47.03 |
| 163 | 7 | 11 | 9 | 27 | 7.60 | 7.22 | 12.18 | 14.93 | 16.45 | 30.11 | 20.49 | 46.61 |
| 164 | 6 | 9 | 12 | 27 | 7.59 | 7.23 | 12.18 | 14.85 | 16.37 | 29.93 | 20.38 | 45.93 |
| 165 | 9 | 4 | 14 | 27 | 7.60 | 7.21 | 12.19 | 14.77 | 16.33 | 29.76 | 20.29 | 45.29 |
| 166 | 11 | 7 | 9 | 27 | 7.62 | 7.21 | 12.17 | 14.75 | 16.23 | 29.65 | 20.21 | 44.88 |
| 167 | 0 | 13 | 14 | 27 | 7.57 | 7.25 | 12.18 | 15.01 | 16.33 | 29.49 | 20.28 | 42.72 |
| 168 | 8 | 4 | 15 | 27 | 7.58 | 7.23 | 12.20 | 14.92 | 16.30 | 29.36 | 20.19 | 42.33 |
| 169 | 3 | 9 | 15 | 27 | 7.55 | 7.24 | 12.21 | 14.95 | 16.22 | 29.23 | 20.14 | 41.64 |
| 170 | 10 | 12 | 5 | 27 | 7.56 | 7.26 | 12.17 | 14.90 | 16.26 | 29.36 | 20.17 | 42.52 |
| 171 | 6 | 6 | 15 | 27 | 7.56 | 7.26 | 12.19 | 14.83 | 16.17 | 29.24 | 20.08 | 42.24 |
| 172 | 9 | 7 | 11 | 27 | 7.56 | 7.26 | 12.18 | 14.75 | 16.08 | 29.07 | 19.97 | 41.75 |
| 173 | 8 | 12 | 7 | 27 | 7.57 | 7.28 | 12.15 | 14.67 | 16.11 | 29.06 | 19.95 | 41.87 |
| 174 | 13 | 1 | 13 | 27 | 7.60 | 7.25 | 12.16 | 14.75 | 16.24 | 28.90 | 19.96 | 40.26 |
| 175 | 7 | 3 | 17 | 27 | 7.59 | 7.22 | 12.18 | 14.67 | 16.25 | 28.86 | 19.93 | 40.33 |
| 176 | 1 | 9 | 17 | 27 | 7.56 | 7.23 | 12.21 | 14.83 | 16.18 | 28.83 | 19.95 | 39.76 |
| 177 | 6 | 7 | 14 | 27 | 7.55 | 7.23 | 12.22 | 14.76 | 16.09 | 28.69 | 19.85 | 39.37 |
| 178 | 14 | 6 | 7 | 27 | 7.58 | 7.22 | 12.19 | 14.91 | 16.01 | 28.68 | 19.86 | 39.03 |
| 179 | 4 | 4 | 19 | 27 | 7.56 | 7.21 | 12.23 | 14.90 | 15.97 | 28.77 | 19.88 | 39.72 |
| 180 | 4 | 8 | 15 | 27 | 7.45 | 7.21 | 12.24 | 14.88 | 15.89 | 28.65 | 19.81 | 39.29 |
| 181 | 1 | 13 | 13 | 27 | 7.51 | 7.24 | 12.25 | 15.04 | 15.98 | 28.50 | 19.84 | 37.64 |
| 182 | 7 | 9 | 11 | 27 | 7.51 | 7.25 | 12.24 | 14.96 | 15.91 | 28.35 | 19.74 | 37.23 |
| 183 | 14 | 14 | −1 | 27 | 7.54 | 7.29 | 12.17 | 15.10 | 16.07 | 29.14 | 20.11 | 41.00 |
| 184 | 2 | 14 | 11 | 27 | 7.51 | 7.33 | 12.16 | 15.18 | 16.23 | 28.99 | 20.13 | 39.42 |
| 185 | 3 | 14 | 10 | 27 | 1.49 | 7.36 | 12.15 | 15.21 | 16.38 | 26.86 | 20.15 | 38.17 |
| 186 | 8 | 10 | 9 | 27 | 7.49 | 7.38 | 12.13 | 15.13 | 16.33 | 28.76 | 20.07 | 37.97 |
| 187 | 0 | 6 | 21 | 27 | 7.45 | 7.31 | 12.18 | 15.35 | 16.25 | 29.02 | 20.21 | 38.99 |
| 188 | 6 | 13 | 8 | 27 | 7.44 | 7.40 | 12.16 | 15.28 | 16.33 | 28.96 | 20.19 | 38.65 |
| 189 | 2 | 6 | 19 | 27 | 7.41 | 7.39 | 12.20 | 15.35 | 16.25 | 39.05 | 20.22 | 39.14 |
| 190 | 9 | 2 | 16 | 27 | 7.42 | 7.36 | 12.22 | 15.28 | 16.32 | 28.97 | 20.16 | 38.74 |
| 191 | 10 | 13 | 4 | 27 | 7.43 | 7.39 | 12.17 | 15.24 | 16.40 | 29.17 | 20.27 | 39.85 |
| 192 | 12 | 5 | 10 | 27 | 7.46 | 7.38 | 12.16 | 15.27 | 16.34 | 29.04 | 20.22 | 39.15 |
| 193 | 9 | 6 | 12 | 27 | 7.47 | 7.37 | 12.16 | 15.20 | 16.27 | 28.89 | 20.12 | 28.68 |
| 194 | 9 | 9 | 9 | 27 | 7.47 | 7.38 | 12.14 | 15.13 | 16.20 | 28.79 | 20.04 | 38.50 |
| 195 | 2 | 4 | 21 | 27 | 7.45 | 7.36 | 12.19 | 15.21 | 16.17 | 29.05 | 20.14 | 39.80 |
| 196 | 14 | 1 | 12 | 27 | 7.48 | 7.33 | 12.19 | 15.35 | 16.29 | 28.90 | 20.18 | 38.15 |
| 197 | 7 | 5 | 15 | 27 | 7.48 | 7.32 | 12.20 | 15.27 | 16.24 | 28.79 | 20.10 | 37.92 |
| 198 | 11 | 11 | 5 | 27 | 7.49 | 7.34 | 12.17 | 15.25 | 16.22 | 28.90 | 20.13 | 38.67 |
| 199 | 6 | 6 | 15 | 27 | 2.49 | 7.33 | 12.18 | 15.19 | 16.15 | 28.80 | 20.05 | 38.46 |
| 200 | 10 | 10 | 7 | 27 | 7.50 | 7.35 | 12.16 | 15.14 | 16.11 | 28.79 | 20.01 | 28.66 |

1. A method of designing a network given a set of network nodes, a set of adjacencies defining which nodes can be connected together directly and so are topologically adjacent and a traffic matrix comprising a plurality of entries each indicating a source node, a destination node and a number being the number of connections from the source node to the destination node that are to be present in the network; the method comprising the steps of:
a) simulating the network nodes and the adjacencies thereof to generate a simulated network;
b) simulating applying the traffic matrix entry by entry, each application of an entry causing a number of links consistent with the entry to be simulated between the source and destination nodes indicated in the entry, via a chain of topologically adjacent nodes;
c) simulating the effect of at least one failure on the simulated network, including simulating the re-routing of the links onto a replacement chain where the chain is broken;
d) determining the number of links between each pair of topologically adjacent nodes;
e) repeating steps (a) to (d) for a plurality of iterations, the order in which the entries in the traffic matrix and the faults are applied being different in different iterations;
f) for each iteration and for each topologically adjacent pair of nodes, determining an average number of links between the pair of nodes for all iterations so far;
g) for each iteration and for each pair of topologically adjacent pair of nodes, determining a variance in the average number of links for all iterations so far;
h) for each iteration, determining an average variance in the average number of links for all iterations so far, the average being taken across the entire network;
i) for each iteration, determining a variance in the variances in the average number of links for all iterations so far, the variance being taken across the entire network; and
j) determining when to cease iterating based upon the variance in the variances in the average number of links.

2. The method of claim 1, comprising the step of storing and/or outputting, as a number of links to be provided between each topologically adjacent pair of nodes, the average number of links for that pair of nodes.

3. The method of claim 1, further comprising implementing the network in line with the number of links to be provided between each topologically adjacent pair of nodes.

4. The method of claim 1, in which step (j) of the method comprises determining whether the variance in the variances in the average number of links is below a threshold.

5. The method of claim 1, in which step (j) comprises determining whether the variance in the variances in the average number of links has converged to within a predetermined margin of error.

6. The method of claim 1, in which the entries in the traffic matrix each comprise an indication of protection desired for the link.

7. The method of claim 6, in which the protection desired comprises at least one of the following:
1:1 protection, where a backup channel is provided for every link;
1:N protection, where a backup channel is provided for every N links;
Fast ReRoute, where every link in a chain is protected by a backup path that commences from the first node in the link that can be activated should that link fail;
on the fly;
shared risk link group, where any protection circuit cannot be carried over a physical link that is likely to fail at the same time as the link itself; and
link or node diversity.

8. The method of claim 6, in which step (b) comprises simulating both the link and the protection desired.

9. The method of claim 6, in which step (c) comprises simulating rerouting of a failed link based on the protection applied to the link in line with the protection desired.

10. The method of claim 1, in which the set of adjacencies includes data relating to the physical connections between the nodes.

11. The method of claim 1, in which the entries in the traffic matrix comprise an indication of the bandwidth to be carried by the links.

12. The method of claim 1, in which the network is a synchronous network.

13. The method of claim 12, in which the network is one of a synchronous digital hierarchy (SDH) and a synchronous optical networking (SONET).

14. A computer program, which when loaded onto a suitable computer, takes a set of network nodes, a set of adjacencies defining which nodes can be connected together directly and so are topologically adjacent and a traffic matrix comprising a plurality of entries each indicating a source node, a destination node and a number being the number of connections from the source node to the destination node that are to be present in the network and causes the computer to carry out the following method:
a) simulating the network nodes and the adjacencies thereof to generate a simulated network;
b) simulating applying the traffic matrix entry by entry, each application of an entry causing a number of links consistent with the entry to be simulated between the source and destination nodes indicated in the entry, via a chain of topologically adjacent nodes;
c) simulating the effect of at least one failure on the simulated network, including simulating the re-routing of the links onto a replacement chain where the chain is broken;
d) determining the number of links between each pair of topologically adjacent nodes;
e) repeating steps (a) to (d) for a plurality of iterations, the order in which the entries in the traffic matrix and the faults are applied being different in different iterations;
f) for each iteration and for each topologically adjacent pair of nodes, determining an average number of links between the pair of nodes for all iterations so far;
g) for each iteration and for each pair of topologically adjacent pair of nodes, determining a variance in the average number of links for all iterations so far;
h) for each iteration, determining an average variance in the average number of links for all iterations so far, the average being taken across the entire network;
i) for each iteration, determining a variance in the variances in the average number of links for all iterations so far, the variance being taken across the entire network; and
j) determining when to cease iterating based upon the variance in the variances in the average number of links.

15. A computer, programmed to take a set of network nodes, a set of adjacencies defining which nodes can be connected together directly and so are topologically adjacent and a traffic matrix comprising a plurality of entries each indicating a source node, a destination node and a number being the number of connections from the source node to the destination node that are to be present in the network and to carry out the following method:
a) simulating the network nodes and the adjacencies thereof to generate a simulated network;
b) simulating applying the traffic matrix entry by entry, each application of an entry causing a number of links consistent with the entry to be simulated between the source and destination nodes indicated in the entry, via a chain of topologically adjacent nodes;
c) simulating the effect of at least one failure on the simulated network, including simulating the re-routing of the links onto a replacement chain where the chain is broken;
d) determining the number of links between each pair of topologically adjacent nodes;
e) repeating steps (a) to (d) for a plurality of iterations, the order in which the entries in the traffic matrix and the faults are applied being different in different iterations;
f) for each iteration and for each topologically adjacent pair of nodes, determining an average number of links between the pair of nodes for all iterations so far;
g) for each iteration and for each pair of topologically adjacent pair of nodes, determining a variance in the average number of links for all iterations so far;
h) for each iteration, determining an average variance in the average number of links for all iterations so far, the average being taken across the entire network;
i) for each iteration, determining a variance in the variances in the average number of links for all iterations so far, the variance being taken across the entire network; and
j) determining when to cease iterating based upon the variance in the variances in the average number of links.
